(19) United States
(12) Patent Application Publication
(10) Pub. No.: US 2019/0304330 A1
(43) Pub. Date: Oct. 3, 2019

(54) COMPLIANCE SYSTEM FOR USE WITH JANITORIAL AND CLEANING PRODUCTS

(71) Applicant: MIDLAB, INC., Athens, TN (US)

(72) Inventors: Matthew Jon Schenk, Knoxville, TN (US); Paul Scoonover, Knoxville, TN (US); Stacey DeHart, Knoxville, TN (US); Mark Perriguey, Powell, TN (US); Brookney Morrell, Knoxville, TN (US); Melissa Fagan, Knoxville, TN (US); Derek Shropshire, Newport, TN (US); Kira Chelsey Smith, Nashville, TN (US); Jordan Kooijman, Knoxville, TN (US)

(73) Assignee: MIDLAB, INC., Athens, TN (US)

(21) Appl. No.: 16/256,585

(22) Filed: Jan. 24, 2019

Related U.S. Application Data
(60) Provisional application No. 62/649,726, filed on Mar. 29, 2018.

(51) Int. Cl. G09B 19/00; G09B 1/40; G09B 5/02

(52) U.S. Cl. CPC G09B 19/00; G09B 5/02; G09B 1/40

(57) ABSTRACT

A system and method for training and guiding cleaning professionals in the use of janitorial and cleaning products, includes specifically configured labels for the products and a variety of visual and other support materials provided via a website that are configured to facilitate training of the end user. The support materials are complementary to the labels so that after the end user has been trained using the visual support materials, the labels reinforce the training and provide on-site reminders of proper and effective use of the products.

### CROSS REFERENCE TO RELATED APPLICATION

This application claims priority to U.S. Provisional Application Ser. No. 62/649,726 entitled COMPLIANCE SYSTEM FOR USE WITH JANITORIAL AND CLEANING PRODUCTS, filed Mar. 29, 2018, incorporated by reference herein in its entirety.

### FIELD

This disclosure relates to the field of education and training. More particularly, this disclosure relates to a compliance system for use with cleaning products. The system is configured as an educational and training system for cleaning professionals, and in particular, a system having specially configured labels for products and a cooperating website having training materials that facilitates training and guiding cleaning professionals in the use of a wide variety of janitorial and cleaning products.

### BACKGROUND

Improvement is desired in regard to training cleaning professionals in the proper and safe use of janitorial and cleaning products. Cleaning products used by commercial cleaning services are effective and cost effective when properly used. However, proper and safe use of the products is not always intuitive, and improper use of janitorial and cleaning products can have safety concerns, be wasteful, and not provide desired cleaning results. Moreover, there are a large number of different products for different jobs, each having unique use requirements.

Coupled with this are aspects of professional cleaning operations having new personnel, personnel who do not have extensive education, who may not be fluent in the local language, and other factors that complicate the training of cleaning professionals in the proper and safe use of a variety of different janitorial and cleaning products.

Accordingly, what is desired is an effective system for training cleaning professionals in the use of janitorial and cleaning products. In particular, there is a need for a system that results in improved compliance and proper and effective use of janitorial and cleaning products by users.

### SUMMARY

The above and other needs are met by a system for training and guiding in the recommended use of products.

In one aspect, the training system includes a plurality of products. Each product has a specially configured label for the product. Each specially configured label has a written product description, a sequence of numbered steps arranged in a recommended step-by-step order of use of the product, icons corresponding to each of the numbered steps, and written indicia or indicium corresponding to each of the steps.

Training materials are provided via a website for each of the products for training a user in recommended use of the products. The training materials are complimentary to the specially configured labels and include information describing the labels, the written product description of the labels, the sequence of numbered steps of the labels, the icons of the labels, and the written indicia or indicium corresponding to each of the steps.

The labels reinforce the training of the user in recommended use of the products and the labels thereafter when viewed by the user during use of one or more of the products serve to remind the user of the recommended use.

In another aspect, there is provided a system for training and guiding cleaning professionals in recommended use of janitorial and/or cleaning products. This system includes a plurality of janitorial and/or cleaning products. Each product has a specially configured label for the product. Each specially configured label has a written product description, a sequence of numbered steps arranged in a recommended step-by-step order of use of the product, icons corresponding to each of the numbered steps, and written indicia or indicium corresponding to each of the steps.

Training materials provided via a website for each of the products for training a user in recommended use of the products. The training materials are complimentary to the specially configured labels and include information describing the labels, the written product description of the labels, the sequence of numbered steps of the labels, the icons of the labels, and the written indicia or indicium corresponding to each of the steps.

The labels reinforce the training of the user in recommended use of the products and the labels thereafter when viewed by the user during use of one or more of the products serve to remind the user of the recommended use.

In yet another aspect, there is provided a method for training and guiding in recommended use of products. The method includes as steps the step of providing a plurality of products. Each product has a specially configured label for the product. Each specially configured label has a written product description, a sequence of numbered steps arranged in a recommended step-by-step order of use of the product, icons corresponding to each of the numbered steps, and written indicia or indicium corresponding to each step of the sequence of numbered steps.

In another step, training materials are provided via a website for each of the products for training a user in recommended use of the products. The training materials are complimentary to the specially configured labels and include information describing the labels, the written product description of the labels, the sequence of numbered steps of the labels, the icons of the labels, and the written indicia or indicium corresponding to each of the steps.

In another step, a user is provided access to the training materials to be trained in recommended use of the products. The labels reinforce the training of the user in recommended use of the products and the labels thereafter when viewed by the user during use of one or more of the products serve to remind the user of the recommended use.

### BRIEF DESCRIPTION OF THE DRAWINGS

Further advantages of the disclosure are apparent by reference to the detailed description when considered in conjunction with the figures, which are not to scale so as to more clearly show the details, wherein like reference numbers indicate like elements throughout the several views, and wherein:

FIGS. 1A, 1B, and 1C depict components of training systems according to the disclosure.

FIGS. 2A and 2B show labels utilized in the training systems.

FIG. 3 shows a training brochure utilized in the training systems.

FIGS. 4A and 4B show training posters utilized in the training systems.

FIGS. 5A and 5B show product information sheets utilized in the training systems.

FIGS. 6A-6B show webpages utilized in the training systems, and FIG. 6C shows icons utilized in the training systems.

FIGS. 7A-7F show screen shots of a video utilized in the training systems.

### DETAILED DESCRIPTION

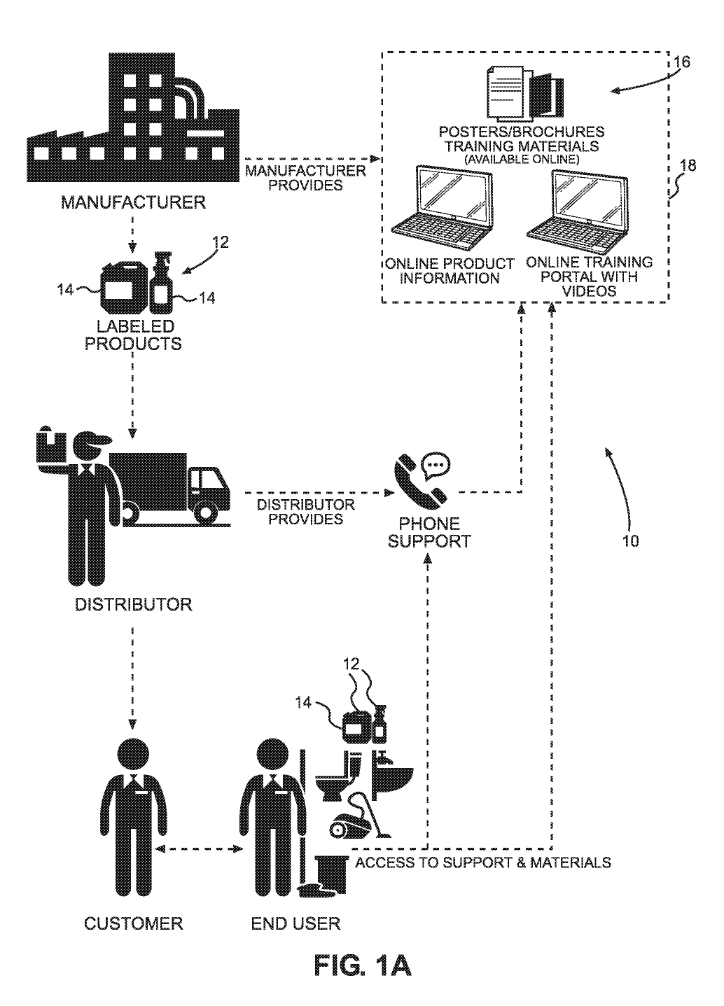

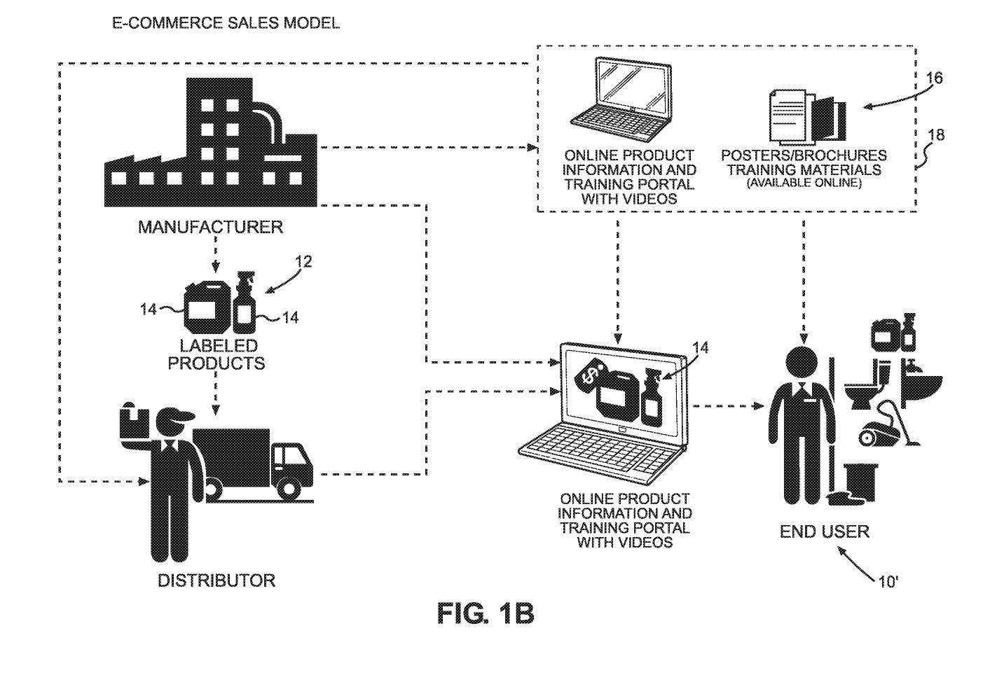

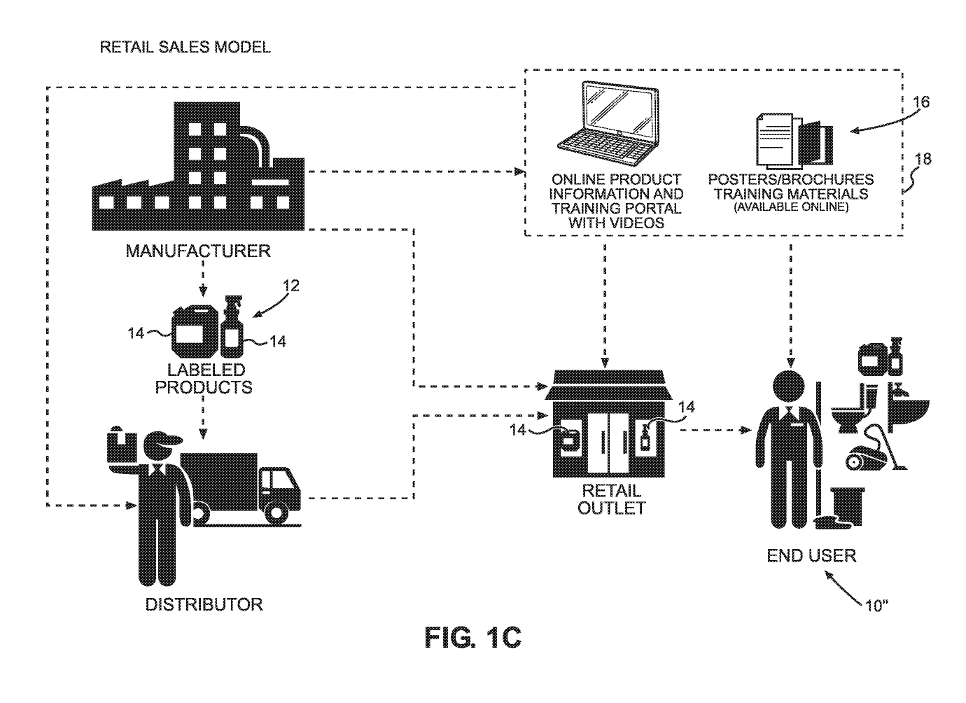

With initial reference to FIG. 1A there is shown system 10 for the sale of janitorial and cleaning products that includes training and guiding cleaning professionals in the use of janitorial and cleaning products according to the disclosure. The system 10 has been observed to improve compliance in the effective and proper use of janitorial and cleaning products.

In overview, the system 10 includes a plurality of janitorial and cleaning products 12 having labels 14 that are provided ultimately to an end user, such as a janitor. The labels 14 are specially configured to facilitate proper and effective use of the janitorial and cleaning products.

The system 10 is configured to support use of the products 12 having the labels 14, with a variety of visual and other support materials 16 provided via a website 18. The website 18 enables the materials 16 to be available to the end user 24 hours a day, 7 days a week. The materials 16 are configured to facilitate training of the end user. The materials are complementary to the labels 14 so that after the end user has been trained using the visual support materials 16, the labels 14 reinforce the training and provide on-site reminders of proper and effective use of the products 12.

The system 10 is configured to be easily adopted and complementary to a commercial janitorial customer of the type that utilizes a large staff of end users and obtains products from a manufacturer via a distributor. In this regard, the training of the end users may be complemented by enabling direct contact of the end users with the distributor for additional product support, such as phone or video support or the like provided by providing access to such support via the website 18.

The system 10 is configured for sales of the janitorial and cleaning products 12 via a distributor. FIGS. 1B and 1C show alternative systems 10′ and 10″ that provide similar systems configured for e-commerce and retail sales of the janitorial and cleaning products 12. The systems 10′ and 10″ are similarly configured to support use of the products 12 having the labels 14, with the visual and other support materials 16 provided via the website 18.

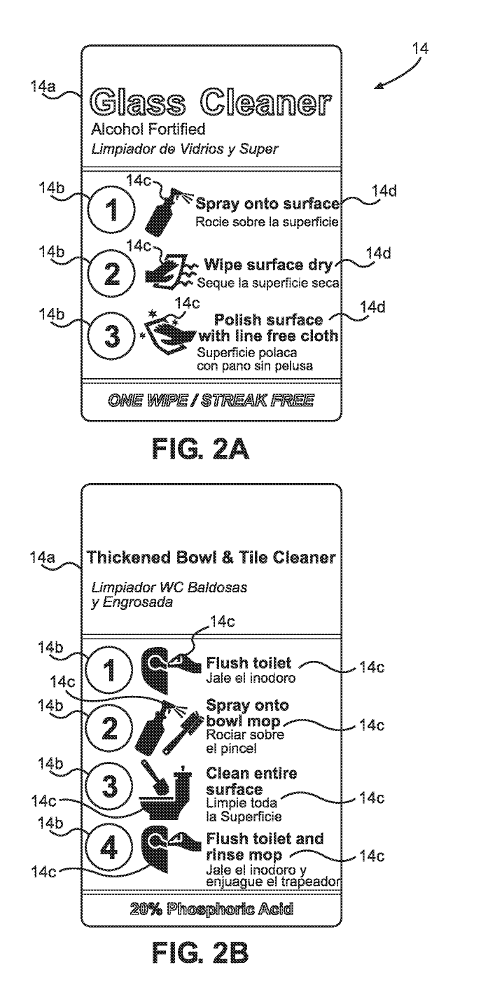

FIGS. 2A and 2B show examples of labels 14 that are applied to the products 12 for use with the training systems 10, 10′ and 10″. The labels 14 are specifically configured to simplify information that is vital to understand for proper and safe use of a particular janitorial or cleaning product 12. Examples of janitorial and cleaning products include deodorants, disinfectants, sanitizers and cleaners, such as toilet bowl cleaners, glass cleaners, oven cleaners, hard floor cleaners, carpet cleaners, tile cleaners, degreasers for industrial applications, degreasers for kitchens, truck and automobile cleaning, and the like.

With reference to FIG. 2A, the label 14 shown therewith is for an alcohol fortified product designed for cleaning glass surfaces. The label 14 includes four components: A product description 14a, a sequence of numbered steps 14b, icons 14c corresponding to each of the steps 14b, and written indicia or indicium 14d corresponding to each of the steps 14b.

The product description 14a is located and configured to be prominent on the label 14, and preferably in at least two languages most likely to represent the languages spoken by the end users to be trained. For example, for the Southern United States, the description 14a is preferably provided in at least English and Spanish. The product description 14a is a simplified description of the product 12 and provided in font or type that is the largest font or type on the label 14. The product description 14a is preferably provided in four words or less.

The numbered steps 14b correspond to proper and safe use of the product in a recommended step-by-step order corresponding to how the end user will be taught about proper and safe use of the product in accordance with the system of the disclosure, and the most common use of the product. For example, for use of the glass cleaner, the steps 14b include three steps: proper application of the product, i.e., by spraying, proper working of the product, i.e., wiping until dry, and completion, i.e., polishing with a lint free cloth. Typically, the numbered steps will be from about three to about six steps.

The icons 14c correspond to the numbered steps. For example, an icon showing spraying of the product for the application step, an icon showing a hand wiping with a towel for the working step, and an icon showing a hand polishing with a cloth for the completion step.

The written indicia or indicium 14d also corresponds to each of the steps 14b. For example, next to the icon for the application step is the wording “Spray onto surface” in both English and Spanish. Next to the icon for the working step is the wording “Wipe surface dry” in both English and Spanish. Next to the icon for the completion step is the wording “Polish surface with lint free cloth” in both English and Spanish.

Turning to FIG. 2B, there is a similarly configured label 14 for a thickened bowl and tile cleaner, having a product description 14a of: “Thickened Bowl & Tile Cleaner”. The numbered steps 14b correspond to proper and safe use of the product in a recommended step-by-step order corresponding to how the end user will be taught about proper and safe use of the product in accordance with the system of the disclosure and the most common use of the product. For example, for use of the bowl and tile cleaner, the steps 14b include four steps: initial preparation, i.e., flush the toilet; proper application of the product, i.e., by spraying onto a bowl mop, proper working of the product, i.e., clean entire surface, and completion, i.e., flush toilet and rinse mop.

The icons 14c correspond to the numbered steps 14b. For example, an icon showing a hand flushing the toilet, spraying of the product onto a bowl mop for the application step, an icon showing a mopping of the toilet for the working step, and an icon showing a hand flushing the toilet for the completion step. Thus, the icons are drawings that convey the action to be taken or not to be taken.

The written indicia or indicium 14d also corresponds to each of the steps 14b. For example, next to the icon for the preparation step is the wording “Flush toilet” in both English and Spanish. For the application step is the wording “Spray onto bowl mop” in both English and Spanish. Next to the icon for the working step is the wording “Clean entire surface” in both English and Spanish. Next to the icon for the completion step is the wording “Flush toilet” in both English and Spanish.

In some cases, it is advisable not to take an action, such as spraying the product on a painted surface. Thus, following a spray step with a spray icon, the next step would have a NO icon with the written indicia 14d next to it being not to spray on painted surfaces.

The visual and other support materials 16 with which the labels 14 are configured to complement include training brochures 16a, training posters 16b, product information sheets 16c, product specific webpages 16d, and product training videos 16e.

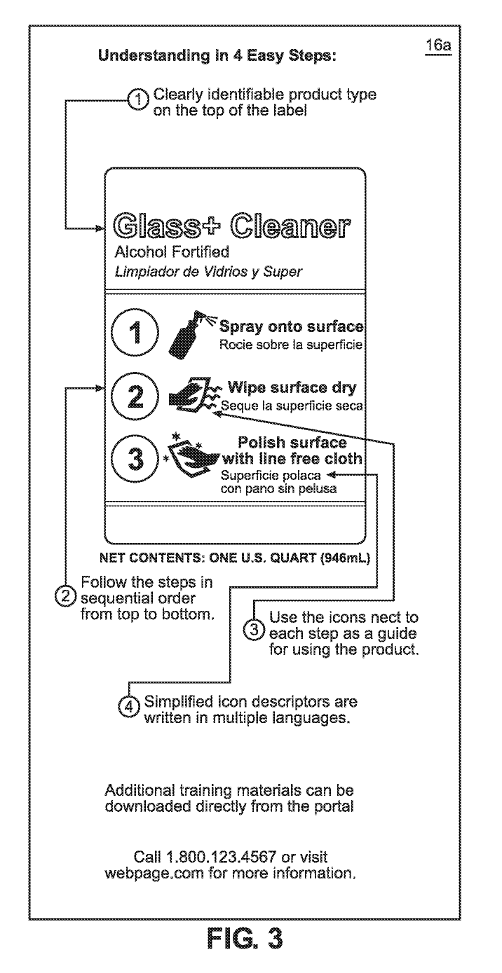

FIGS. 3A-3B show examples of the training brochures 16a. The training brochures 16a are configured to cooperate with and complement the labels 14. For example, brochures 16a describe the labels 14 and elaborate on the layout, purpose and information provided by the product description 14a, the sequence of numbered steps 14b, the icons 14c corresponding to each of the steps 14b, and the written indicia or indicium 14d corresponding to each of the steps 14b. The brochures 16a emphasize how the labels 14 identify which of the products 12 is to be utilized for a given cleaning task, proper use of the product, including the sequence to be followed.

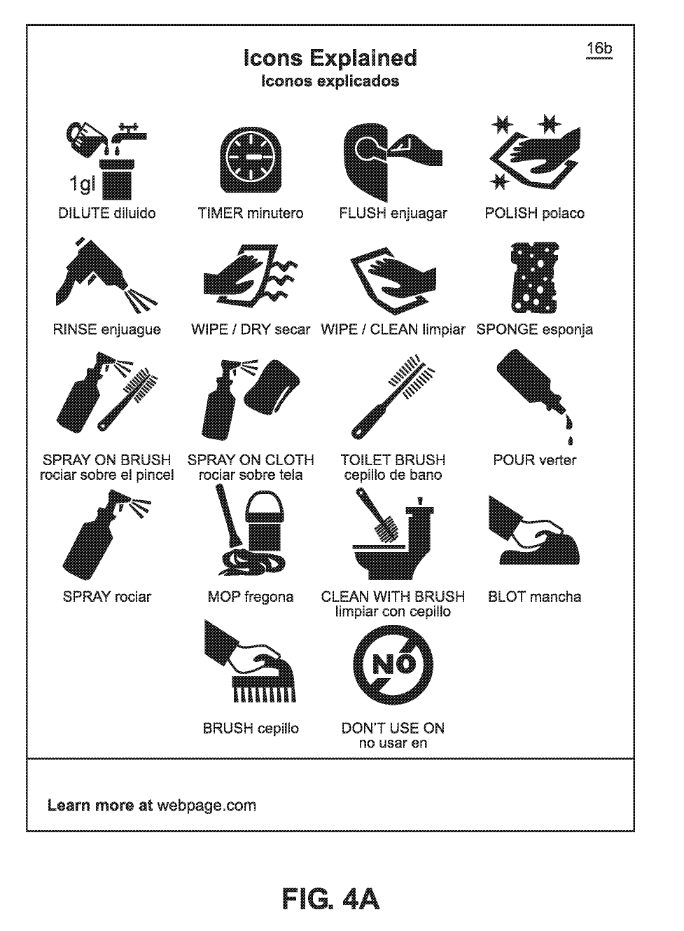

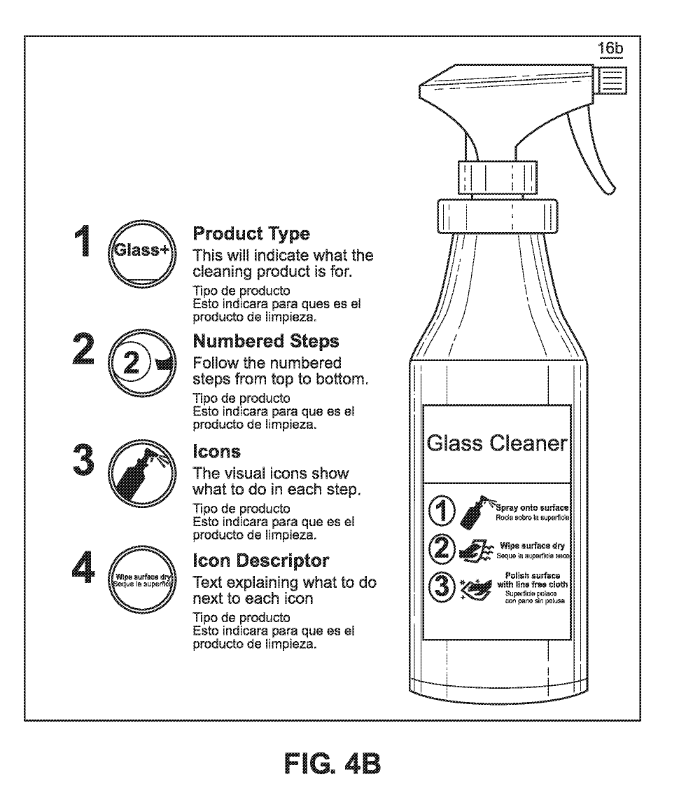

FIGS. 4A-4B show examples of the training posters 16b. The posters 16b complement the brochures 16a, and further cooperate with and complement the labels 14. For example, the posters 16b provide training of the meaning of the icons 14c, and further elaborate on the layout, purpose and information provided by the product description 14a, the sequence of numbered steps 14b, the icons 14c corresponding to each of the steps 14b, and the written indicia or indicium 14d corresponding to each of the steps 14b.

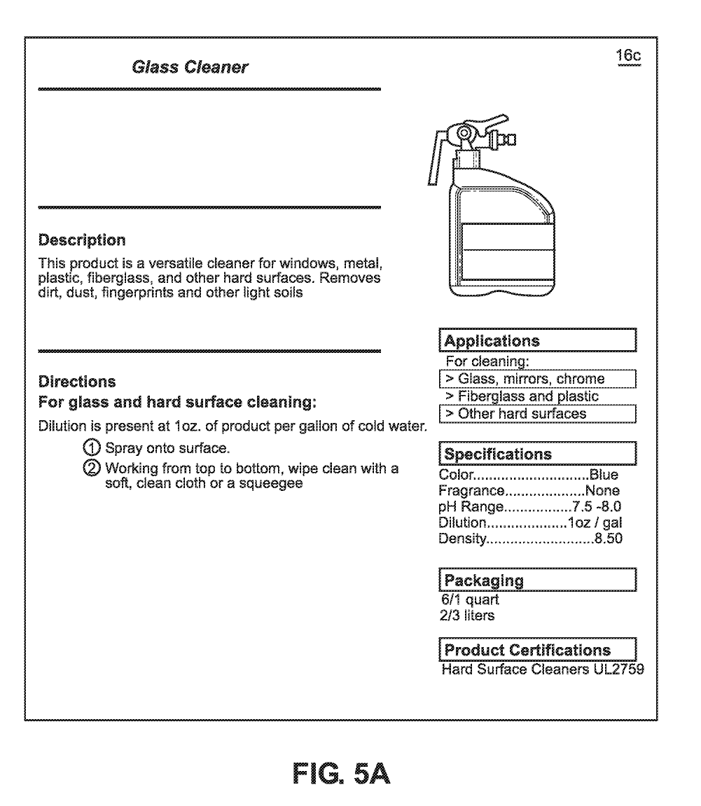

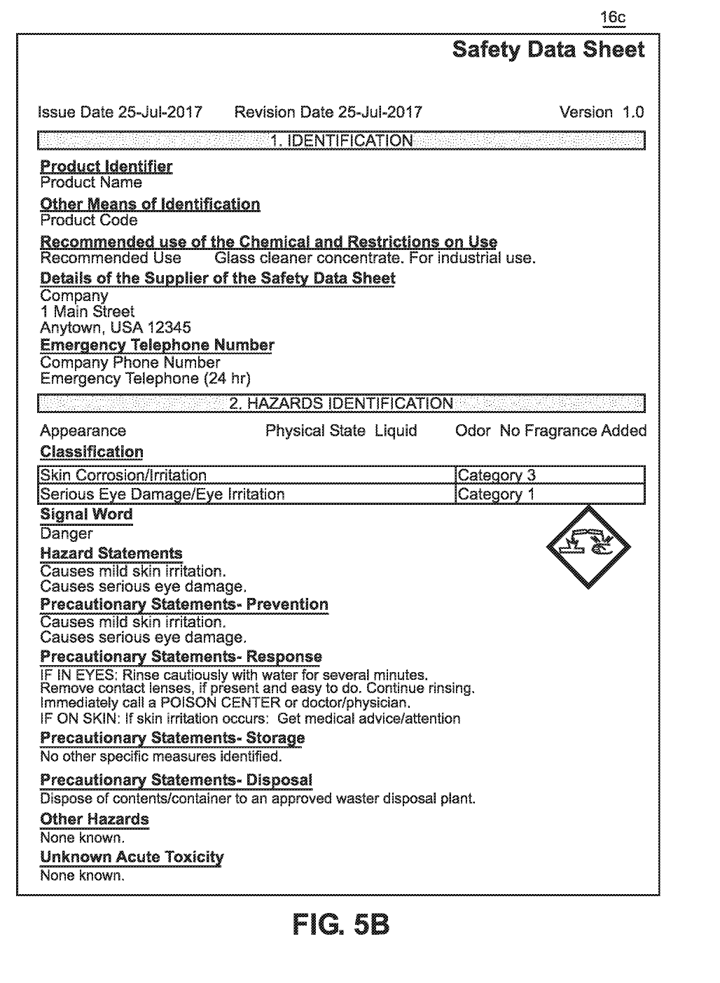

FIGS. 5A-5B show examples of the product information sheets 16c. The information sheets 16c may provide basic information about the purpose, use, and chemistry, or other factual matters of the products 12. For example, the information sheets 16c that may be provided are safety data sheets and product information supplied by the manufacturer of the products 12.

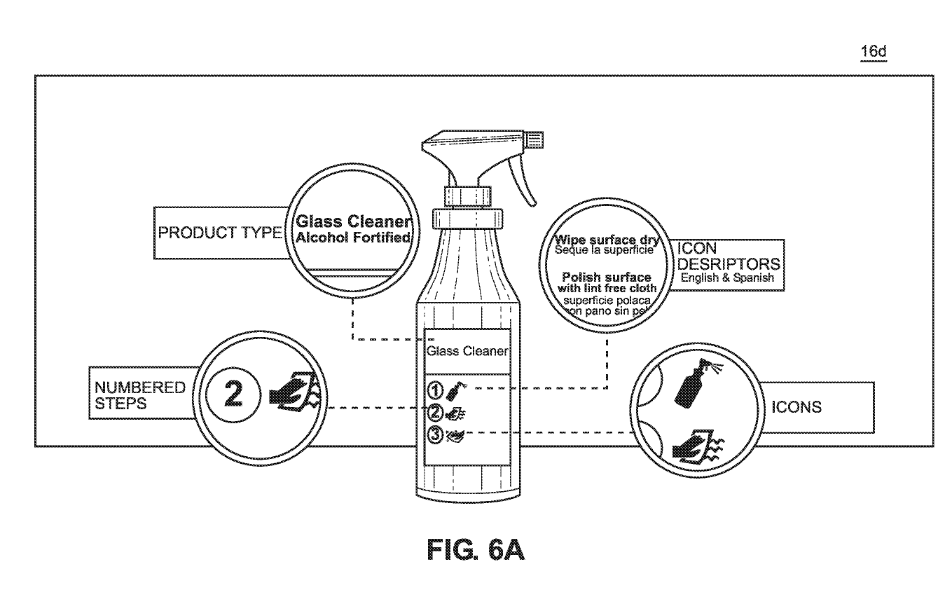

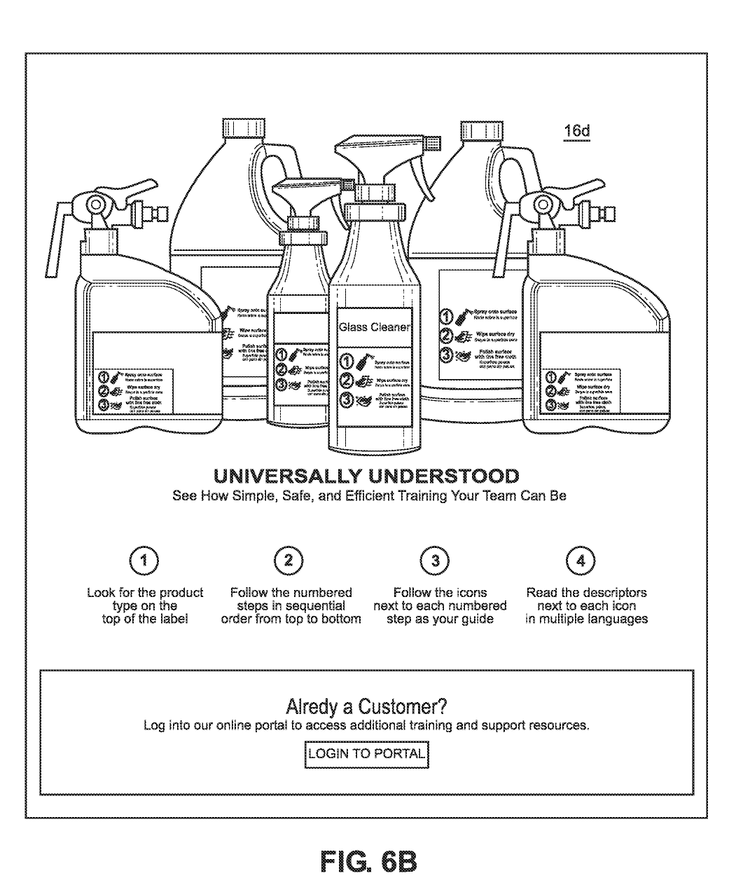

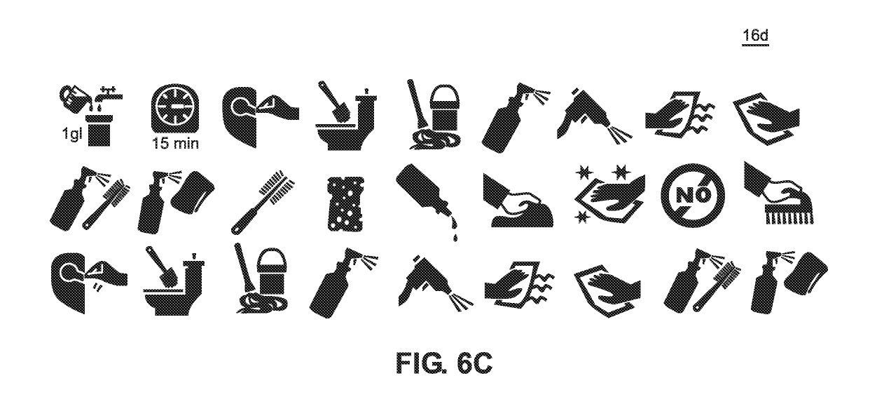

FIGS. 6A-6C show examples of the webpages 16d. The webpages 16d provide a brief overview of the information on the labels 14 and direct users to other training materials, such as the training video 16e.

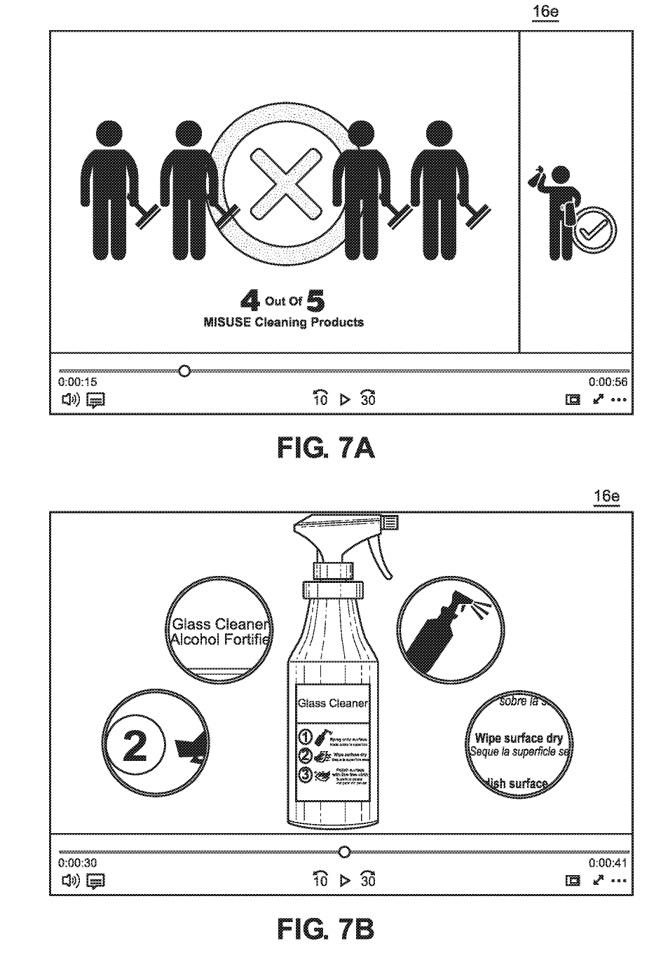

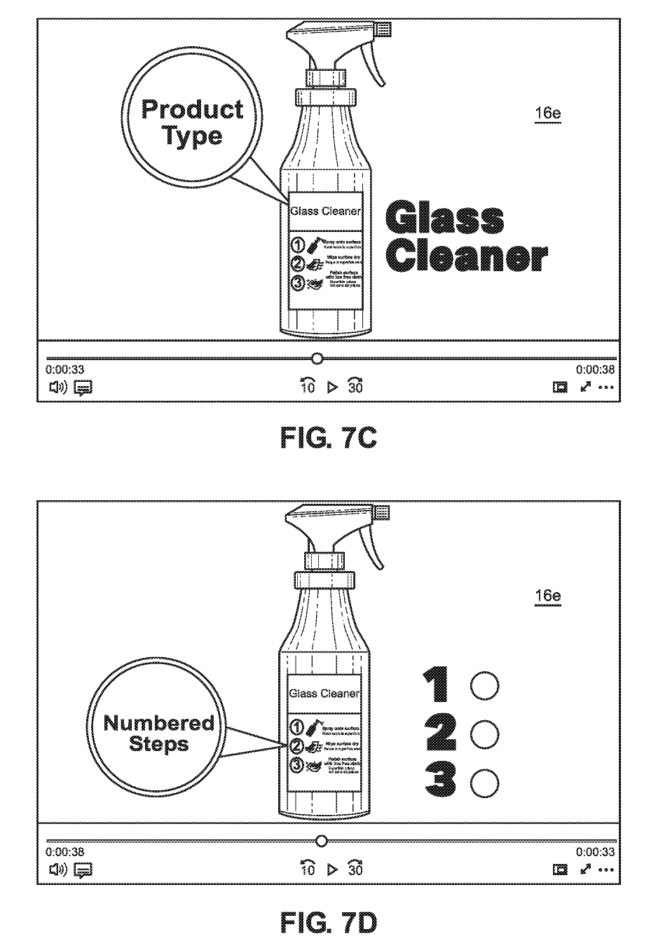

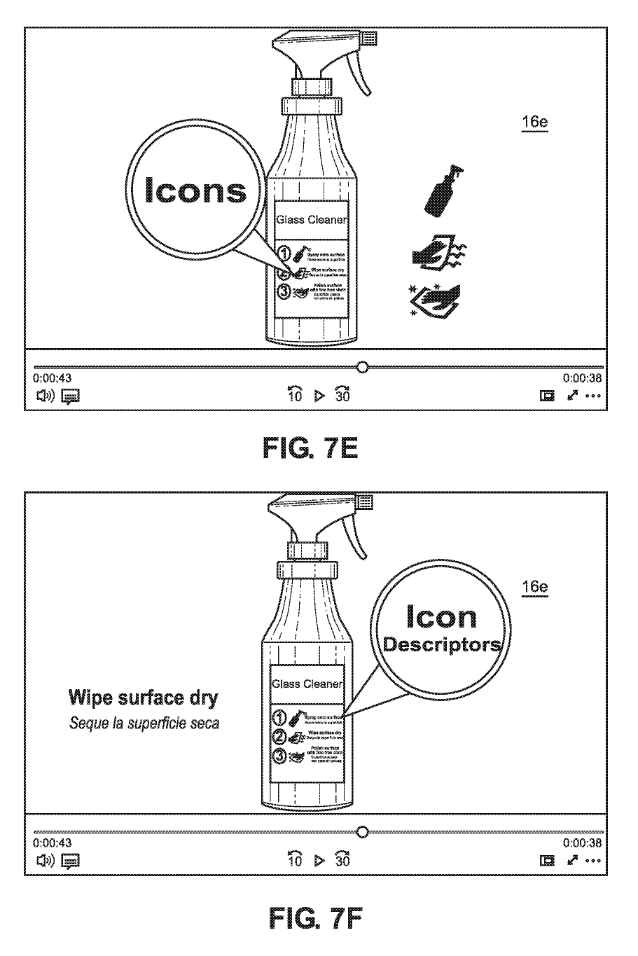

FIGS. 7A-71 show screen shots of an example training video 16e. The video provides an overview of the importance of training in the use of the products 12, and sequentially walks a viewer through the information provided on the labels 14. The video 16e complements the brochures 16a and the posters 16b, and further cooperate with and complement the labels 14.

For example, the video 16e teaches end users the layout, purpose and information provided by the product description 14a, the sequence of numbered steps 14b, the icons 14c corresponding to each of the steps 14b, and the written indicia or indicium 14d corresponding to each of the steps 14b. The video 16e emphasizes how the labels 14 identify which of the products 12 is to be utilized for a given cleaning task, proper use of the product, including the sequence to be followed. The video 16e can further direct end users to additional support materials.

During training with the systems 10, 10′ and 10″ according to the disclosure, the end user will be taught about proper use of products for their intended purpose. The end user will be taught in a manner and using materials that explain and give additional substance to the abbreviated information provided on the labels 14. However, in the training process, it has been observed that end users learn to follow the information on the labels 14, and later, during use of the products in the work environment where they have only the product labels 14 to reference, have improved ability to engage in proper use of the products 12 in recommended step-by-step order.

For example, end users not utilizing the training systems 10, 10′ and 10″ with the labels 14 and materials 16 have been observed to make proper use of cleaning and janitorial products only about 20 percent of the time. As will be appreciated, this can be unsafe, wasteful, and result in undesirable cleaning. This is especially the case in an environment where the end user utilizes a variety of different cleaning and janitorial products on a variety of cleaning jobs.

To the contrary, it has been observed that end users utilizing the training systems 10, 10′ and 10″ with the labels 14 and materials 16 make proper use of cleaning and janitorial products over about 80 percent of the time. Thus, the training systems 10, 10′ and 10″ enable an effective system for training and guiding end users in the use of janitorial and cleaning products. Furthermore, the systems 10, 10′ and 10″ enable end users to remotely access training materials and the like on an ongoing basis.

The foregoing description of preferred embodiments for this disclosure has been presented for purposes of illustration and description. It is not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

1. A system for training and guiding in recommended use of products, the system comprising:
a plurality of products, each product having a specially configured label for the product, each specially configured label having a written product description, a sequence of numbered steps arranged in a recommended step-by-step order of use of the product, icons corresponding to each of the numbered steps, and written indicia or indicium corresponding to each of the steps; and
training materials provided via a website for each of the products for training a user in recommended use of the products, the training materials being complimentary to the specially configured labels and including information describing the labels, the written product description of the labels, the sequence of numbered steps of the labels, the icons of the labels, and the written indicia or indicium corresponding to each of the steps;
wherein the labels reinforce the training of the user in recommended use of the products and the labels thereafter when viewed by the user during use of one or more of the products serve to remind the user of the recommended use.

2. The system of claim 1, wherein the product description is provided in at least two different languages.

3. The system of claim 1, wherein the product description is in a font or type that is the largest font or type on the label.

4. The system of claim 1, wherein the product description comprises no more than about five words.

5. The system of claim 1, wherein the sequence of numbered steps comprises from about three to about six steps.

6. The system of claim 1, wherein each of the icons comprises a drawing that convey the action to be taken or not to be taken for each of the numbered steps.

7. The system of claim 1, wherein the written indicia or indicium corresponding to each of the steps is provided in at least two different languages.

8. The system of claim 1, wherein the training materials comprise training brochures, training posters, product information sheets, product specific webpages, product training videos, and combinations thereof.

9. The system of claim 1, wherein the products comprise janitorial or cleaning products or both.

10. A system for training and guiding cleaning professionals in recommended use of janitorial and/or cleaning products, the system comprising:
a plurality of janitorial and/or cleaning products, each product having a specially configured label for the product, each specially configured label having a written product description, a sequence of numbered steps arranged in a recommended step-by-step order of use of the product, icons corresponding to each of the numbered steps, and written indicia or indicium corresponding to each of the steps; and
training materials provided via a website for each of the products for training a user in recommended use of the products, the training materials being complimentary to the specially configured labels and including information describing the labels, the written product description of the labels, the sequence of numbered steps of the labels, the icons of the labels, and the written indicia or indicium corresponding to each of the steps;
wherein the labels reinforce the training of the user in recommended use of the products and the labels thereafter when viewed by the user during use of one or more of the products serve to remind the user of the recommended use.

11. A method for training and guiding in recommended use of products, comprising the steps of:
providing a plurality of products, each product having a specially configured label for the product, each specially configured label having a written product description, a sequence of numbered steps arranged in a recommended step-by-step order of use of the product, icons corresponding to each of the numbered steps, and written indicia or indicium corresponding to each of the steps;
providing training materials via a website for each of the products for training a user in recommended use of the products, the training materials being complimentary to the specially configured labels and including information describing the labels, the written product description of the labels, the sequence of numbered steps of the labels, the icons of the labels, and the written indicia or indicium corresponding to each of step of the of the sequence of numbered steps; and
providing a user access to the training materials to be trained in recommended use of the products, wherein the labels reinforce the training of the user in recommended use of the products and the labels thereafter when viewed by the user during use of one or more of the products serve to remind the user of the recommended use.

12. The method of claim 11, wherein the product description is provided in at least two different languages.

13. The method of claim 11, wherein the product description is in a font or type that is the largest font or type on the label.

14. The method of claim 11, wherein the product description comprises no more than about five words.

15. The method of claim 11, wherein the sequence of numbered steps comprises from about three to about six steps.

16. The method of claim 11, wherein each of the icons comprises a drawing that convey the action to be taken or not to be taken for each of the numbered steps.

17. The method of claim 11, wherein the written indicia or indicium corresponding to each of the steps is provided in at least two different languages.

18. The method of claim 11, wherein the training materials comprise training brochures, training posters, product information sheets, product specific webpages, product training videos, and combinations thereof.

19. The method of claim 11, wherein the products comprise janitorial or cleaning products or both.
